(19) United States
(12) Patent Application Publication
(10) Pub. No.: US 2021/0177192 A1
(43) Pub. Date: Jun. 17, 2021

(54) APPARATUS FOR REMOVING COFFEE FOAM FROM COFFEE LIQUID

(71) Applicant: SPENGLER GMBH & CO. KG, Bruchsal (DE)

(72) Inventor: Xaver Ralf Heuberger, Albersweiler (DE)

(73) Assignee: SPENGLER GMBH & CO. KG, Bruchsal (DE)

(21) Appl. No.: 17/056,509

(22) PCT Filed: Jun. 25, 2019
(86) PCT No.: PCT/EP2019/066756

§ 371 Date: Nov. 18, 2020

(30) Foreign Application Priority Data
Jun. 26, 2018 (DE) 10 2018 005 029.8

(51) Int. Cl. A47J 31/46

(52) U.S. Cl. CPC A47J 31/467; A47J 31/461

(57) ABSTRACT

A device for the removal of coffee foam from coffee liquid, comprising a tank having a tank interior, which is bounded by a peripheral tank wall as well as a tank bottom, with an inlet arranged above the tank bottom, via which the tank interior can be filled with coffee liquid, as well as with a liquid outlet arranged at the base of the tank bottom, from which the coffee liquid that has been freed of coffee foam can be discharged from the tank interior, is characterized in that the tank bottom converges toward the liquid outlet in a funnel-like manner and has a plurality of peripheral steps, which are arranged one above the other in a terrace-like manner, each of which has a peripheral step face and a vertical step wall arranged at an angle to it, the two of which

### BACKGROUND

### 1. Field of the Disclosure

The present disclosure relates to a device for the removal of coffee foam from coffee liquid.

### 2. Discussion of the Background Art

For most coffee drinkers, one of the most important characteristics of espresso is the thick layer of foam referred to as crema, which rests on top of the beverage after it has been poured into a cup. Crema is the Italian word for cream and is the natural head of foam that forms on the coffee after it has been poured—similar to the foam on a glass of beer.

The reason for the formation of crema—which, in the present patent application, is also referred to, in general, as coffee foam—lies in the fact that the water supplied for the brewing operation is under very high pressure. As a result, it can dissolve more of the carbon dioxide that is generated during roasting of the coffee than it can at atmospheric pressure. When, after the brewing operation, the coffee liquid is exposed to atmospheric pressure once again on its way to the cup, the liquid can no longer hold the carbon dioxide contained in it, as a result of which the carbon dioxide leaves the liquid in the form of countless small bubbles. These bubbles are trapped in the coffee liquid and act as a stable foam.

Crema was long regarded as important, but, in reality, only two conclusions can be drawn from its presence. First, whether the coffee powder used is fresh, because the longer the period of time that has elapsed since the coffee beans used to make it were roasted, the less carbon dioxide it contains; second, whether the brewed coffee, in particular espresso, is strong or weak. The darker the foam, the stronger is the coffee, because the crema consists solely of coffee liquid bubbles, in which carbon dioxide is contained and which reflect the light accordingly. The darker the coffee liquid, the darker is also the crema, this being the reason why darkly roasted coffee produces dark crema. However, the color of the crema says nothing about the quality of the coffee beans used.

Even though, in many Mediterranean cultural milieus, such as, for example, in Italy, the crema is regarded as a key quality feature of coffee beverages, in particular of espresso, the presence of crema is not desired in Scandinavian cultural milieus, for example, where it is regarded instead as interfering with the enjoyment of coffee beverages.

In the automatic preparation of coffee beverages in coffee machines, a special problem is posed in that the desired coffee beverage is to be brewed from freshly ground coffee beans in the brewing unit within a time that is as short as possible and is to be dispensed from the coffee machine via the coffee outlet, so that there is intrinsically no longer any time for the undesired crema, that is, the coffee foam, to separate from the coffee liquid. This is the reason why, in particular in the case of espresso, which is brewed under high pressure, a thick crown of crema foam is, as a rule, always present on the dispensed coffee liquid and leads, after cooling, to unattractive deposits or rim stains formed from burst and dried-out coffee foam bubbles at the inner sides of the cups into which the freshly brewed coffee beverage has been dispensed.

Accordingly, the problem of the present disclosure is to create a device by means of which coffee foam can be removed from coffee liquid reliably and in the shortest time possible.

A further problem of the present disclosure is to create a coffee machine that is capable of providing a freshly brewed coffee beverage, in particular espresso, in the shortest time possible and essentially without any coffee foam.

### SUMMARY

In accordance with the disclosure, a device for the separation of coffee foam from coffee liquid comprises a tank having a tank interior, which is bounded by a peripheral tank wall as well as a tank bottom.

The device further comprises an inlet, which is arranged above the tank bottom and via which the tank interior can be filled with coffee liquid. To this end, the coffee liquid is brewed, preferably automatically, from freshly ground coffee beans in a known brewing unit; however, it is also possible alternatively to prepare the coffee liquid semi-manually in a known way in a known espresso machine. The device according to the disclosure further comprises a liquid outlet that is arranged at the base of the tank bottom and from which the coffee liquid that has been freed of coffee foam is discharged from the tank interior. The tank can be closed at its top side, preferably by a lid, in order to prevent the penetration of dirt or other contaminants or the escape of coffee vapor and moisture into the interior of a coffee machine in which the device is to be used.

The device according to the disclosure is characterized in that the tank bottom converges in a funnel-like manner toward the liquid outlet and has a plurality of peripheral steps that are arranged one above the other in a terrace-like manner. The terrace-like peripheral steps each have a peripheral step face and a step wall that is arranged at an angle to it, the two of which adjoin each other at a step edge. Although the steps can also have breaks, such as, for example, separating walls or separating strips that extend perpendicularly to the step faces and step walls, they preferably extend continuously peripherally and have no breaks or separating walls, so that the step faces as well as the step walls and the step edge all extend peripherally in a closed manner.

The disclosure affords the advantage that the coffee foam bubbles or crema bubbles that are released after the brewing operation on account of the drop in pressure in the coffee liquid are popped or burst at the peripheral step edges when the level of the liquid inside of the tank interior drops. In this way, the carbon dioxide contained in the coffee foam bubbles is released and the coffee liquid forming the shells of the coffee foam bubbles can flow back into the coffee liquid in a still fluid state and in a still liquid and chemically unchanged form via the step faces and step walls of the underlying terrace-like peripheral steps, while this coffee liquid gradually flows out of the tank interior via the liquid outlet. A special advantage of the disclosure is hereby that, on account of the still very high temperature of the coffee liquid and the relatively short time that has elapsed since the coffee liquid was poured into the tank, the temperature of the coffee liquid that forms the walls of the coffee foam bubbles hardly drops at all, so that the chemical composition thereof remains unchanged when the liquid from the bubble walls reenters the draining coffee liquid.

In the preferred embodiment of the disclosure, the step face of each individual step is arranged at an inclination to the liquid outlet at an angle of 0° to +10°, preferably 2.5° to 7°, with respect to a horizontally extending plane. As the applicant has found, this special geometric design of the steps results in an especially effective popping of the coffee foam bubbles, which leads to a nearly complete elimination of coffee foam bubbles from the coffee liquid.

At the same time or alternatively, it can further be provided that the vertical step wall of each individual step encloses an angle of between 77.5° and 90° with the step face that adjoins it, thereby further improving the efficiency of separation of the coffee foam bubbles.

In order to ensure that the level of the coffee liquid draining via the liquid outlet is always parallel to the step edges or step faces in the region of the step edges as well as the step faces, the preferred embodiment of the device according to the disclosure comprises adjustment devices, by means of which the spatial position of the tank can be changed. Such adjustment devices can be set screws, for example, by means of which the tank, for example, rests against the housing of the coffee machine that contains the device. In the same way, however, the adjustment devices can also be situated at the level of adjustable feet, on which the housing of a coffee machine that contains the device rests. Through the provision of adjustment devices, it can be ensured in a mechanically simple way that all of the peripheral step faces are always inclined toward the center of the tank and the peripheral step edges are aligned horizontally. This horizontal alignment ensures that, after the coffee liquid has drained from the tank interior, no residual poolings of coffee liquid, in which coffee foam that has not been removed can collect, can form on the step faces and, in short order, lead to interfering contamination in the device.

Although the tank of the device according to the disclosure can have a circular cross-sectional shape in plan view, it has an essentially rectangular cross-sectional shape in the preferred embodiment of the disclosure; that is, more precisely, it has the shape of an oblong rectangle with two parallel longer sides and two parallel short sides, which are respectively joined to each other through rounded corner regions. In the region of a first imaginary plane that extends between the shorter sides of the tank, the peripheral step faces hereby have a step depth that is greater than the step depth of the same step in the region of a second imaginary plane that extends perpendicularly to the first imaginary plane between the longer sides of the tank. This geometric design of the tank results in a tank shape that is spatially optimized in comparison to a tank having a circular cross section and has a lower installation volume and an enlarged face and edge length of the steps.

In accordance with a further idea on which the disclosure is based, the peripheral step faces are inclined toward the liquid outlet at an angle of between 1° and 5°, preferably 2.5°, with respect to the horizontal in the region of the imaginary plane that extends between the shorter sides of the tank interior, whereby preferably all step faces in the respective regions have the same angle of inclination. This affords the advantage that, after the tank has been filled, the coffee liquid flows off over the entire step face at essentially the same speed, thereby counteracting the formation of flow vortices, which, among other things, can lead once again to the formation of new, additional coffee foam bubbles.

In order to promote still further the breakdown of the coffee foam bubbles in the coffee liquid, the surface of the step faces and/or of the step walls can have a structure with a roughness profile, the arithmetic mean of the profile ordinates, Ra, of which has a value between 1.1 μm and 6.3 μm in accordance with DIN EN ISO 4287 (1998-10) and DIN EN ISO 4288, and the greatest height Rz of which lies between 4.7 μm and 24.0 in accordance with the same standard. As the applicant has found, the use of such a structure surprisingly leads to a marked reduction of coffee foam bubbles in the coffee liquid.

At the same time or else alternatively, the peripheral step faces in the region of the imaginary plane that extends between the longer sides of the tank interior can be inclined at an angle of between 5° and 10°, preferably 7.5°, with respect to the horizontal, leading—as the applicant has found—to the best possible defoaming of the coffee liquid in these regions.

The effectiveness of the defoaming of the coffee liquid can be further increased in the aforementioned oblong tank geometry with a length of the tank interior of 90 mm and a width of 45 mm in that, in the region of the imaginary plane extending between the shorter sides of the tank, the vertical step wall of each individual one of the preferably seven steps encloses an angle of between 70° and 90°, preferably 77.5°, with the step face that adjoins it, whereas the vertical step walls of each individual step in the region of the imaginary plane extending between the longer sides of the tank advantageously enclose an angle of between 80° and 100°, preferably 90°, with the step face that adjoins it. As the applicant has found, the specified angles enable the observation of an especially efficient bursting of the coffee foam bubbles floating on top of the coffee liquid, as a result of which the number of the steps that are required in the case of espresso can be reduced to only seven steps in order to achieve a nearly complete elimination of all of the coffee foam.

Obviously, the number of steps used for the respective coffee beverage can be adjusted and can vary between, for example, two steps for conventional coffee and, for example, 10 steps for espresso.

In the preferred embodiment of the disclosure, the liquid outlet has an outlet channel, which has an oblong, essentially rectangular cross-sectional shape or an oval cross-sectional shape. This affords the advantage that the length of the step edge that surrounds the outlet channel is enlarged in comparison to an outlet channel with a circular outlet opening, thereby additionally promoting, in turn, the bursting of the coffee foam bubbles at the last step edge in the region of the tank bottom and improving the separation effect of the device.

In order to eliminate also those foam bubbles remaining on the coffee liquid in the region of the center of the tank interior, without having been broken beforehand by way of the preferably seven step edges, it is possible to arrange further terrace-like steps in the side wall of the outlet channel.

As the applicant has found, it is hereby of special advantage in terms of the efficiency of removal of the coffee foam when the further terrace-like steps are arranged on the side of the outlet channel that faces away from tank bottom and when the outlet channel has a smooth-walled channel portion between the base of the tank bottom and the further terrace-like steps, via which the coffee liquid can reach the further terrace-like steps from the tank bottom. In order to rule out as much as possible any vortexing of the coffee liquid that has been freed of coffee foam bubbles and, in association therewith, a re-formation of coffee bubbles in the region of the smooth-walled channel portion, the smooth-walled portion is preferably straight in design.

In accordance with a further underlying idea of the disclosure, an outlet opening is formed below the terrace-like steps, via which the coffee liquid drains from the tank lying above it. The outlet opening is preferably designed in the form of a slit and has a smaller cross-sectional surface than the inlet, via which, for elimination of the coffee foam bubbles, the freshly brewed coffee liquid is introduced in a cascade from the brewing chamber into the tank. The cross-sectional surface of the outlet opening is preferably of such a size that the coffee liquid that has been freed of coffee foam/crema has completely drained from the tank coffee liquid within 10 to 30 seconds. In the case of espresso, the tank can have, for example, a capacity of one to two filled espresso cups, that is, for example, 50 to 100 mL, preferably 80 mL. In the case of conventional black coffee, in contrast, the tank can have a size of one to two filled conventional cups of coffee, that is, a capacity of 100 to 300 mL.

Alternatively, it can be provided that the outlet can be closed by means of a valve, in particular an electromechanically actuated valve. To this end, during or after filling of the coffee liquid, the valve is opened so far that the level of the coffee liquid is raised to a liquid level that lies above or at the height of the steps arranged in a terrace-like manner. The use of an electromechanically actuated valve affords the advantage that the times of passage of the coffee liquid through the tank can be adapted to the respective products, so that, for example, by way of a valve that is ¼ opened, it is possible to obtain an optimal separation of coffee foam bubbles and, on the other hand, when the valve is fully opened, it is possible to achieve a smooth flow of the freshly brewed coffee liquid through the tank, which brings about hardly any separation of coffee foam bubbles at the steps.

In the preferred embodiment of the disclosure, the peripheral tank wall is formed as a one-piece structural part together with the steps formed in it and the tank bottom with the liquid outlet, that is, as an integral structural part, which consists solely of one piece. This piece can be designed, in particular, as a plastic injection-molded part, which preferably can be installed as an insert in a housing for mounting of the tank and can be removed from it once again and which, for example, is found in a coffee machine.

The disclosure further relates to a coffee machine, in particular an espresso machine, that contains an above-described device according to the disclosure.

The disclosure will be described below with reference to the drawings on the basis of a preferred embodiment of the disclosure.

### BRIEF DESCRIPTION OF THE DRAWINGS

FIG. 1 a schematic spatial partial illustration of a coffee machine that has a device according to the disclosure contained in it,

FIG. 2 a sectional illustration of the device according to the disclosure along a sectional plane that extends parallel to the short sides of the tank,

FIG. 3 a further sectional illustration along a sectional plane that extends parallel to the long sides of the tank,

FIG. 4 a an enlarged partial view of the sectional illustration of FIG. 2,

FIG. 4 b an enlarged partial view of the sectional illustration of FIG. 3, and

FIG. 5 a plan view of the tank in a preferred embodiment of the disclosure with an oblong, essentially rectangular tank cross section.

### DETAILED DESCRIPTION OF THE PREFERRED EMBODIMENT

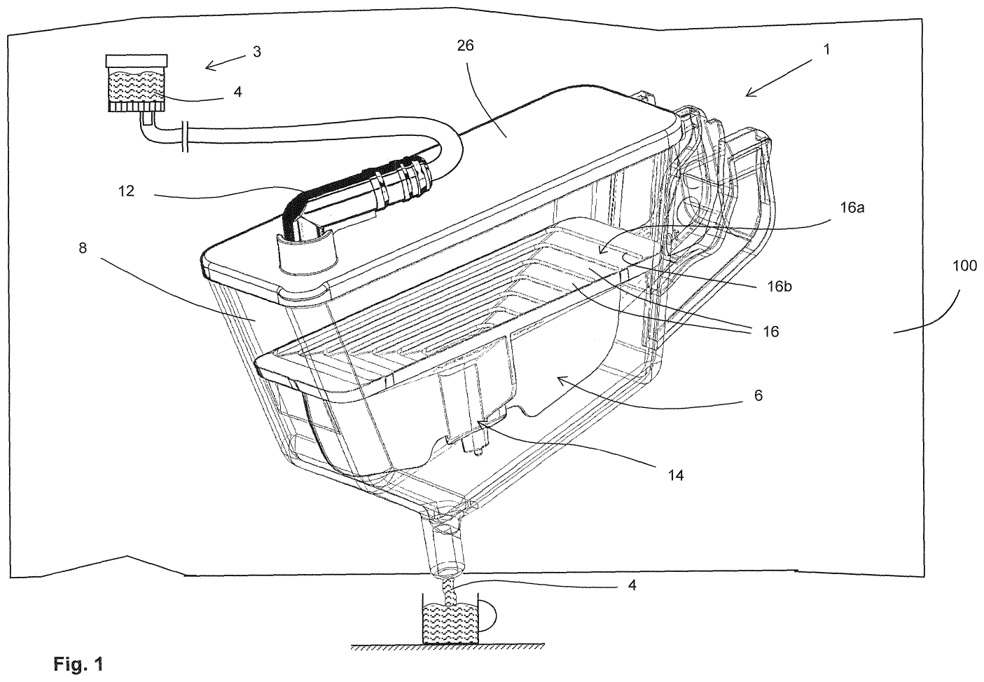

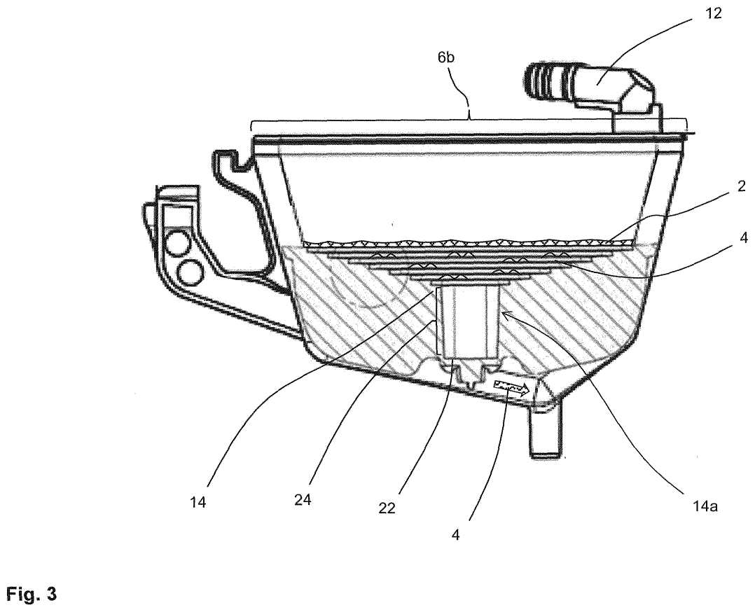

As shown in FIGS. 1 to 5, a device 1 for the separation of coffee foam 2 from coffee liquid 4 for a coffee beverage, which is indicated in FIG. 1, comprises a tank 6 that has a tank interior, which is bounded by a peripheral tank wall 8 as well as a tank bottom 10.

The device 1 further has an inlet 12 for coffee liquid 4, which is arranged above the tank bottom 10 and via which the tank interior can be filled. The coffee liquid 4 is brewed in a brewing unit 3, which is indicated only schematically, but, alternatively, can also be prepared in a known way semi-manually in a known espresso machine.

The device according to the disclosure 1 further comprises a liquid outlet 14, which is arranged at the base of the tank bottom 10 and from which the coffee liquid 4 that has been freed of foam 2 can be discharged from the tank interior. The tank 6, which, in the case of an espresso machine, can have a volume of, for example, 80 mL, can be closed at its top side, preferably by a lid 28, in order to prevent the penetration of dirt or other contaminants or the escape of coffee vapor into the interior of a coffee machine 100, in which the device is to be used and which is indicated only schematically in the drawings.

As can be further seen in the illustrations of FIGS. 1 to 3, the tank bottom 10 converges toward the liquid outlet 14, that is, toward the bottom, in a funnel-like manner and has a plurality of peripheral steps 16, which are arranged one above the other in a terrace-like manner and are arranged peripherally like terraces. In the preferred embodiment of the disclosure, each of the preferably seven steps 16 has a peripheral step face 16a and a vertical step wall 16b, which is arranged at an angle α to said step face, the two of which adjoin each other at a step edge 16c. Although the steps 16 can also have breaks, such as, for example, separating walls that extend perpendicularly to the step faces and step walls, they preferably extend continuously peripherally and have no breaks or separating walls whatsoever, so that the step faces 16a as well as the step walls 16b and step edges 16c all extend peripherally in a closed manner.

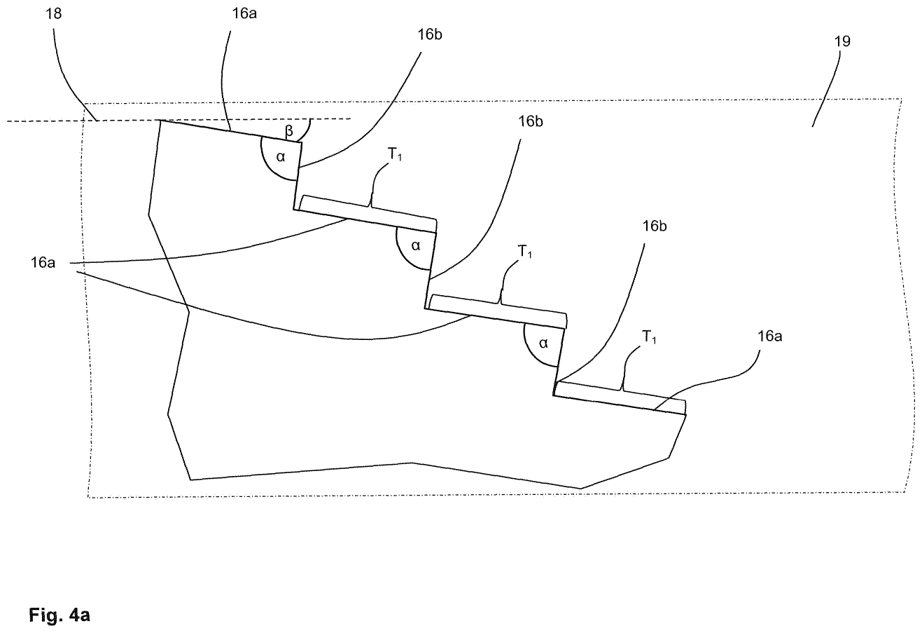

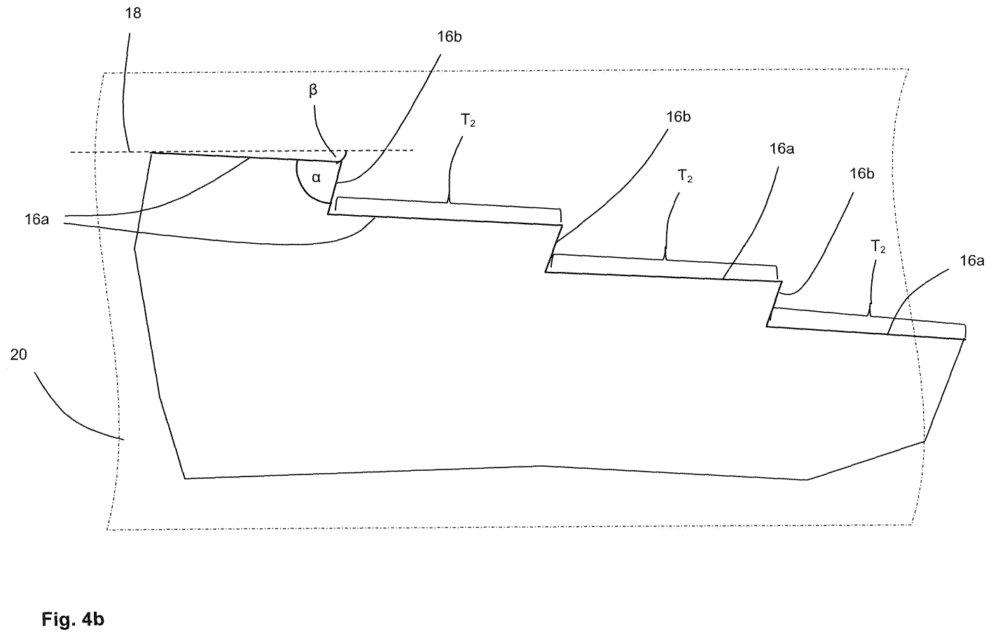

As can be seen in detail in the illustrations of FIGS. 4a and 4b, the step faces 16a of preferably all steps are arranged at an inclination to the liquid outlet 14 at an angle β of 0° to +10°, preferably 2.5° to 7°, with respect to a horizontally extending plane 18. The vertical step wall 16b of each individual step 16 hereby encloses an angle of between 77.5° and 90° with the step face 16a that adjoins it.

In order to ensure that the level of the coffee liquid 4 draining via the liquid outlet 14 always flows parallel to the step edges and step faces in the region of the step edges 16c as well as of the step faces 16a, the preferred embodiment of the device 1 according to the disclosure comprises adjustment devices, which are not shown here in greater detail and via which the spatial position of the tank 6 can be varied. These devices can be set screws, for example, by means of which the tank 6, for example, rests against the housing of the coffee machine 100.

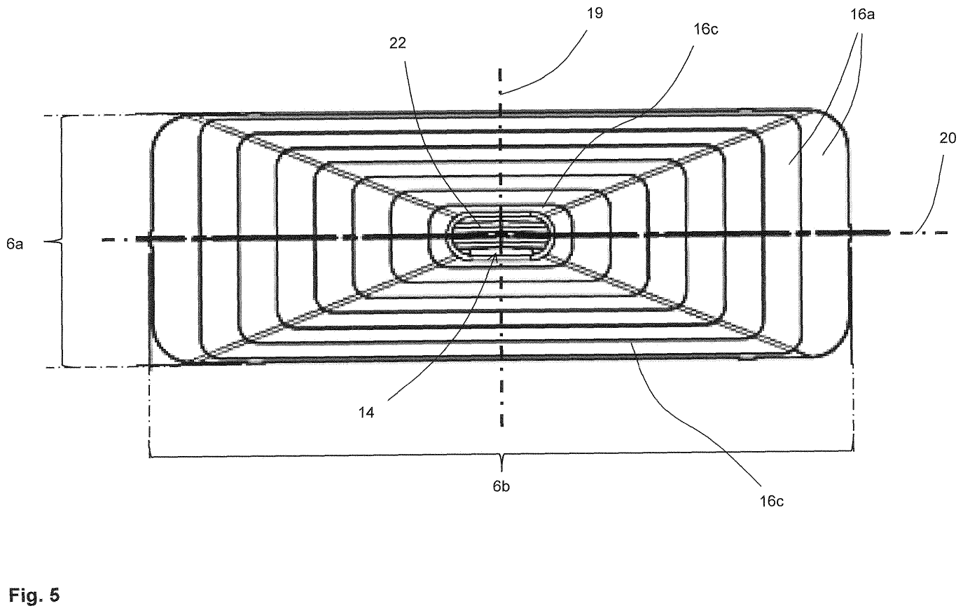

As is further shown in FIG. 1 and in the plan view of FIG. 5 in the preferred embodiment of the disclosure, the tank 6 has an essentially rectangular cross-sectional shape, that is, more precisely, the shape of an oblong rectangle with two parallel longer sides and two parallel short sides, which are respectively joined to each another via rounded edge regions. In the region of a first imaginary plane 19, which is shown in FIG. 4a and extends between the shorter sides 6a of the tank 6, the peripheral step faces 16a hereby have a step depth T1 that is greater than the step depth T2 of the same step in the region of a second imaginary plane 20, which—as shown in FIG. 4b—extends perpendicularly to the first imaginary plane 19 between the longer sides 6b of the tank 6. For a tank length of 90 mm and a tank width of 45 mm, for example, the step depth T1 can be 5 mm and the step depth T2 3.5 mm. In comparison to a tank 6 with a circular cross section, this geometric design of the tank 6 results in a spatially optimized tank shape, which makes possible a reduced installation volume and an enlarged face and edge length of the steps 16.

As can be further seen in detail in the illustrations of FIGS. 4a and 4b, the peripheral step faces 16a are inclined toward the liquid outlet 14 at an angle β of between 1° and 5°, preferably 2.5°, with respect to the horizontal 18 in the region of the imaginary plane that extends between the shorter sides 6a of the tank interior. Preferably all step faces 16a hereby have the same angle of inclination β in the respective regions. In an advantageous manner, this leads to the fact that, during the slow draining of the tank 6 that follows the cascade-like filling operation thereof, the coffee liquid 4 flows off over the entire step face 6a at essentially the same speed, thereby counteracting the formation of flow vortices, which, among other things, can lead to the formation of new, additional coffee foam bubbles.

At the same time or else alternatively, the peripheral step faces 16a can be inclined toward the liquid outlet 14 at an angle β of between 5° and 10°, preferably 7.5°, with respect to the horizontal in the region of the imaginary plane 20 that extends between the longer sides 6b of the tank interior, as shown in FIG. 4a.

In the case of the above-mentioned oblong tank geometry, the effectiveness of the defoaming of the coffee liquid 4 can be further increased in that, in the region of the imaginary plane that extends between the shorter sides 6a of the tank 6, the vertical step wall 16b of each individual one of the preferably seven steps 16 encloses an angle α of between 70° and 90°, preferably 77.5°, with the respective step face 16b that adjoins it. In contrast, in the region of the imaginary plane 20 that extends between the longer sides 6b of the tank 6, the vertical step walls 16b of each individual step 16 preferably enclose an angle α of between 80° and 100°, preferably 90°, with the respective step face 16a that adjoins it, as shown in FIG. 4b.

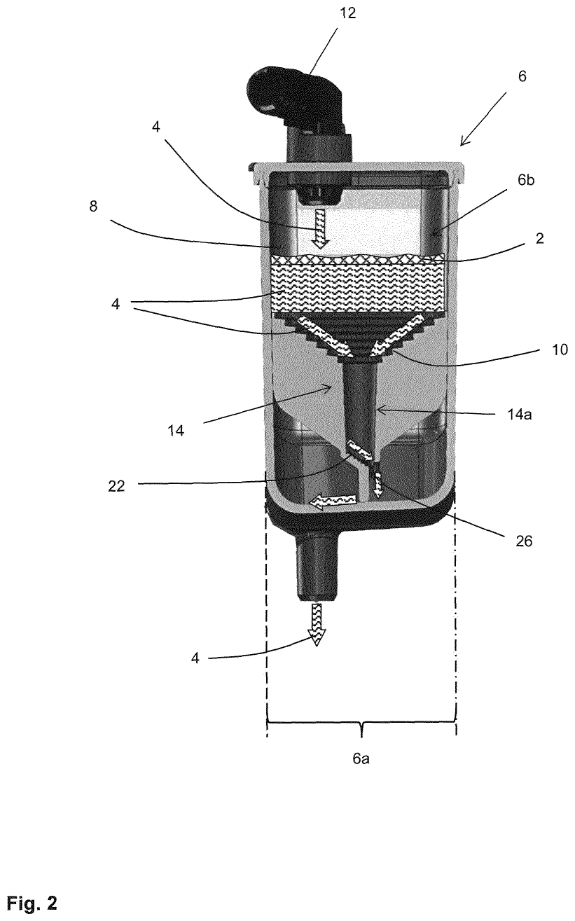

As can be further seen in the illustrations of FIGS. 2, 3, and 5, the liquid outlet 14 has an outlet channel 14a, which has an oblong oval cross-sectional shape. This affords the advantage that the length of the first step edge 16c surrounding the outlet channel 14a is enlarged in comparison to an outlet channel having a circular outlet opening, as a result of which the bursting of the coffee foam bubbles at the last bottommost step edge 16c is additionally promoted in the region of the tank bottom 10.

In order to eliminate also those coffee foam bubbles that remain on the coffee liquid 4 in the region of the center of the tank interior during the draining of the tank 6, it is possible for further terrace-like steps 22 to be formed in the side wall of the outlet channel 14a, as shown in FIG. 2. The further terrace-like steps 22 are preferably arranged on the side of the outlet channel 14a that faces away from tank bottom 10, whereby the outlet channel 14a has a smooth-walled channel portion 24, which is situated between the base of the tank bottom 10 and the further terrace-like steps 22 and which preferably extends vertically and via which the coffee liquid 4 is drained from the tank bottom 10 onto the further terrace-like steps 22. In order to rule out to the greatest extent possible any vortexing of the coffee liquid that has been freed of coffee foam bubbles and, in association therewith, a re-formation of coffee foam bubbles in the region of the smooth-walled channel portion 24, the latter is straight in design, as shown in FIGS. 2 and 4.

In order to promote further the breakdown of the coffee foam bubbles in the coffee liquid 4, the step faces 16a and preferably also the step walls 16b and the outlet channel 24 and the further terrace-like steps 22 advantageously have a surface with a rough structure. In an especially advantageous way, the surface has a roughness profile with an arithmetic mean of the profile ordinates (Ra) in accordance with DIN EN ISO 4287 (1998-10) and DIN EN ISO 4288 of between 1.1 μm and 6.3 μm and the greatest height (Rz) thereof lies between 4.7 μm and 24.0 μm in accordance with the same standard.

In accordance with a further underlying idea of the disclosure, an outlet opening 26 is situated below the terrace-like steps 22, via which the coffee liquid 4 flows out of the tank 6 lying above said outlet opening. The outlet opening 26 is preferably designed in the form of a slit and has a smaller cross-sectional surface than does the inlet 12, via which, for elimination of the coffee foam bubbles, the freshly brewed coffee liquid 4 is introduced in a cascade into the tank 6. The cross-sectional surface of the outlet opening 26 is preferably of such a size that the coffee liquid 4 that has been freed of coffee foam 2 drains completely out of the tank 6, preferably within 10 to 30 seconds. In the case of espresso, for example, the tank 6 can have a capacity of one to two filled cups of espresso, that is, for example, 50 to 100 mL, and, in the preferred embodiment of the disclosure, has a capacity of approximately 80 mL.

Alternatively, it can be provided that the outlet can be closed by way of a valve, in particular an electromechanically actuated valve. To this end, during or after filling of the coffee liquid 4, the inlet 12 is opened so far that the level of the coffee liquid 4 is raised to a liquid level that lies above or at the height of the steps 16 arranged in a terrace-like manner. The use of an electromechanically actuated valve affords the advantage that the times for passage of the coffee liquid through the tank 6 can be adapted to the respective products, so that, for example, it is possible to obtain an optimal separation of coffee foam bubbles 2 by way of a valve that is ¼ opened and, on the other hand, in the case of a fully opened valve, a smooth flow of the freshly brewed coffee liquid 4 through the tank 6 is made possible and brings about hardly any separation of coffee foam bubbles 2 at the steps 6.

In the preferred embodiment of the disclosure, the peripheral tank wall 8 is formed as a one-piece structural part together with the steps 16 formed in it and the tank bottom 10 with the liquid outlet 14, that is, as a structural part that consists of solely one piece. This piece can be designed, in particular, as a plastic injection-molded part, which is preferably installed as an insert in a housing for the mounting of the tank 6 and can be removed once again and which, for example, is found in the coffee machine 100.

### LIST OF REFERENCE SIGNS

1 device according to the disclosure
2 coffee foam/crema
3 brewing unit
4 coffee liquid
6 tank
6a shorter sides of the tank
6b longer sides of the tank
8 peripheral tank wall
10 tank bottom
12 inlet for coffee liquid
14 liquid outlet
14a outlet channel
16 terrace-like peripheral steps
16a step face
16b step wall
16c step edge
18 horizontally extending plane
19 imaginary plane between the shorter sides of the tank
20 imaginary plane between the longer sides of the tank
22 further terrace-like steps
24 smooth-walled channel portion of the outlet channel
26 outlet opening below the terrace-like steps
28 lid for closure of the tank
100 coffee machine
α angle between the step face and the step wall
β angle between the step face and the horizontally extending plane
T₁ step depth of the steps in the region of the plane 19
T₂ step depth of the steps in the region of the plane 20

What is claimed is:

1. A device for the removal of coffee foam from coffee liquid, comprising a tank having a tank interior, which is bounded by a peripheral tank wall as well as a tank bottom, with an inlet arranged above the tank bottom, via which the tank interior can be filled with coffee liquid, as well as with a liquid outlet arranged at the base of the tank bottom, from which the coffee liquid that has been freed of coffee foam can be discharged from the tank interior,
wherein the tank bottom converges toward the liquid outlet in a funnel-like manner and has a plurality of peripheral steps, which are arranged one above the other in a terrace-like manner, each of which has a peripheral step face and a vertical step wall arranged at an angle (α) to it, the two of which adjoin each other at a step edge.

2. The device according to claim 1, wherein
the step face of each individual step is arranged at an inclination to the liquid outlet at an angle (β) of 0° to +10°, with respect to a horizontally extending plane and/or in that the vertical step wall of each individual step encloses an angle of between 77.5° and 90° with the step face that adjoins it.

3. The device according to claim 1
the spatial position of the tank for horizontal alignment of the peripheral steps, which are arranged in a terrace-like manner, can be varied by means of adjustment devices, in particular set screws.

4. The device according to claim 1, wherein,
in plan view, the tank has an essentially rectangular cross-sectional shape and in that, in the region of a first imaginary plane that extends between the shorter sides of the tank, the peripheral step faces have a step depth (T₁) that is greater than the step depth (T₂) of the same step in the region of a second imaginary plane that extends perpendicularly to said first imaginary plane between the longer sides of the tank.

5. The device according to claim 4, wherein
in the region of the imaginary plane that extends between the shorter sides of the tank interior, the peripheral step faces are inclined toward the liquid outlet at an angle (β) of between 1° and 5°, with respect to the horizontal and/or in that, in the region of the imaginary plane that extends between the longer sides of the tank interior, the peripheral step faces are inclined toward the liquid outlet at an angle (β) of between 5° and 10° with respect to the horizontal.

6. The device according to claim 4, wherein,
in the region of the imaginary plane that extends between the shorter sides of the tank, the vertical step wall of each individual step encloses an angle (α) of between 70° and 90°, with the step face that adjoins it and/or in that, in the region of the imaginary plane that extends between the longer sides of the tank, the vertical step wall of each individual step encloses an angle (α) of between 80° and 100° with the step face that adjoins it.

7. The device according to claim 1,
wherein
the liquid outlet comprises an outlet channel, which has an oblong, essentially rectangular cross-sectional shape or an oval cross-sectional shape.

8. The device according to claim 7,
further comprising terrace-like steps which are arranged in the side wall of the outlet channel.

9. The device according to claim 8, wherein
the further terrace-like steps are arranged on the side of the outlet channel that faces away from the tank bottom and in that, between the base of the tank bottom and the further terrace-like steps, the outlet channel has a smooth-walled, straight channel portion, via which the coffee liquid reaches the further terrace-like steps from the tank bottom.

10. The device according to claim 9, wherein
below the terrace-like steps, an outlet opening is formed, via which the coffee liquid drains out of the tank arranged above.

11. The device according to claim 10, wherein
the outlet opening is designed in the form of a slit and has a smaller cross-sectional surface than does the inlet and/or in that the outlet can be closed by way of a valve in such a way that the level of the coffee liquid, when it is poured into the tank interior via the inlet, can be raised to a liquid level that is above or at the height of the steps arranged in a terrace-like manner.

12. The device according to claim 1,
wherein
the peripheral tank wall is formed as a one-piece structural part together with the steps formed in it and the tank bottom with the liquid outlet, in particular as an injection-molded part, which can be installed as an insert in a housing for mounting of the tank.

13. The device according to claim 1,
wherein
the tank can be closed at its top side by a lid.

14. The device according to claim 1,
wherein
the surface of at least one of the step faces and/or one of the step walls has a structure with a roughness profile, the arithmetic mean of the profile ordinates (Ra) of which lies between 1.1 μm and 6.3 μm and the greatest height (Rz) thereof lies between 4.7 μm and 24.0 μm.

15. Coffee machine containing a device for the removal of coffee foam from coffee liquid, comprising a tank having a tank interior, which is bounded by a peripheral tank wall as well as a tank bottom, with an inlet arranged above the tank bottom, via which the tank interior can be filled with coffee liquid, as well as with a liquid outlet arranged at the base of the tank bottom, from which the coffee liquid that has been freed of coffee foam can be discharged from the tank interior,
wherein the tank bottom converges toward the liquid outlet in a funnel-like manner and has a plurality of peripheral steps, which are arranged one above the other in a terrace-like manner, each of which has a peripheral step face and a vertical step wall arranged at an angle (α) to it, the two of which adjoin each other at a step edge.
